(19) United States
(12) Patent Application Publication
(10) Pub. No.: US 2026/0264597 A1
(43) Pub. Date: Sep. 10, 2026

(54) A CAMPER

(71) Applicants: Schalk Willem van der Merwe Meintjies, Pretoria (ZA); Floris Cornelius Buys, Pretoria (ZA)

(72) Inventors: Schalk Willem van der Merwe Meintjies, Pretoria (ZA); Floris Cornelius Buys, Pretoria (ZA)

(21) Appl. No.: 19/471,404

(22) PCT Filed: Apr. 4, 2024
(86) PCT No.: PCT/ZA2024/050012

§ 371 Date: Oct. 1, 2025

(30) Foreign Application Priority Data
Apr. 4, 2023 (ZA) 202304117

(51) Int. Cl. B60P 3/38; B60R 15/04

(52) U.S. Cl. CPC B60P 3/38; B60R 15/04

(57) ABSTRACT

A camper (10) including a compartment (12), sanitary ware mounted within the compartment (12), a support arrangement (14) mounted displaceably within the compartment (12) for supporting camping paraphernalia (16), and a displacement mechanism (18) for allowing displacement of the support arrangement (14) between a stowed condition, wherein the support arrangement is stowed within the compartment, and an extended condition, wherein the support arrangement (14) is displaced out of the compartment (12) in order to permit access to the compartment (12), use of the sanitary ware, and use of the camping paraphernalia (16).

### TECHNICAL FIELD

This invention relates to a camper. In particular, this invention relates to a camper in the form of a caravan.

### SUMMARY OF THE INVENTION

According to a first aspect of the invention, there is provided a camper including:
a compartment;
sanitary ware mounted within the compartment;
a support arrangement mounted displaceably within the compartment for supporting camping paraphernalia; and
a displacement mechanism for allowing displacement of the support arrangement between a stowed condition, wherein the support arrangement is stowed within the compartment, and an extended condition, wherein the support arrangement is displaced out of the compartment in order to permit access to the compartment, use of the sanitary ware, and use of the camping paraphernalia.

The compartment may be defined by a framework of the camper. The compartment may have a length, width, and height in the ranges of 1 000 mm to 2 000 mm, 500 mm to 1 000 mm, and 1 200 mm to 2 500 mm, respectively, preferably in the regions of 1 940 mm, 840 mm, and 2 200 mm, respectively. The compartment may be located on an operatively front end-region of the camper.

It is to be appreciated that a framework of the camper may define a living space, a floor, a roof, side walls, and a chassis assembly including wheels mounted thereon for supporting the framework.

The sanitary ware may include any plumbing fixtures typically found in a bathroom. In particular, the sanitary ware may include any one or more plumbing fixtures of the group including toilets, toilet bowls, basins, sinks, showers, bathtubs, and taps. The sanitary ware may be collapsible or foldable into secondary compartments within the first compartment. It is to be appreciated that the sanitary ware may be inaccessible by the user when the support assembly is in a stowed condition within the compartment. The sanitary ware may be manufactured from any suitable material including ceramic, plastics, or metal. Preferably, the sanitary ware may include a toilet. The toilet may be located towards a side region of the first compartment.

An expansion arrangement may be provided for expanding the size of the compartment, preferably the height of the compartment for facilitating standing therein by the user.

The expansion arrangement may include a panel which may define a roof panel of the compartment in the stowed condition. The panel may be arranged at an incline relative to side walls of the camper. It is to be appreciated that mounting the panel at an incline may improve compactness and/or aerodynamics of the camper when traveling. The panel may be mounted on the framework of the camper so as to be displaceable between a first condition, wherein the compartment is in the stowed condition, and a second displaced condition, wherein the panel is displaced away from the compartment thereby increasing the volume thereof. In particular, the panel may be mounted on the framework via a hinge arrangement. Hydraulic actuators may extend between and interconnect the panel and the framework of the camper for facilitating the displacement of the panel into the displaced condition. The panel may have a generally rectangular shape. The panel may have a length, width, and thickness in the ranges of 1 600 mm to 2 000 mm, 800 mm to 1 000 mm, and 15 mm to 30 mm, respectively. Preferably, the panel may have a length, width, and thickness in the regions of 1 800 mm, 900 mm and 20 mm, respectively. It is to be appreciated that the panel may act as a side wall of the compartment in the displaced condition.

A cover may be provided for covering an opening in the compartment defined by the panel in the displaced condition. The cover may be utilised as any one or more of the group including a screen for creating privacy for the user using the sanitary ware, a roof, and a barrier for reducing a likelihood of the ingress of water, leaves, dust, insects, debris, and the like. The cover may be generally rectangular in shape. The cover may have a length, width, and thickness in the ranges of 1 300 mm to 1 800 mm, 500 mm to 900 mm, and 0.5 mm to 2.5 mm, respectively. Preferably, the cover may have a length, width, and thickness in the regions of 1 450 mm, 770 mm and 1.2 mm, respectively. The cover may be manufactured from any suitable material, preferably being a weather-resistant, a weather-proof, and/or a water-proof material. Preferably, the cover may be manufactured from canvas.

The support arrangement may be collapsible for facilitating stowage thereof in the compartment. The support arrangement may have a length, width and height in the ranges of 1 000 mm to 2 000 mm, 500 mm to 800 mm, and 500 mm to 800 mm, respectively, preferably having a length, width and height in the regions of 1 200 mm, 700 mm, and 660 mm, respectively, in the stowed condition. The support arrangement may have a length, width and height in the ranges of 800 mm to 2 000 mm, 500 mm to 2 000 mm, and 500 mm to 1 000 mm, respectively, preferably having a length, width and height the regions of 1 850 mm, 771 mm, and 786 mm, respectively, in the extended condition. The support arrangement may define any one or more of the group including a working surface, a worktop, a table, a cabinet, a cupboard, and a sink. Preferably, the support arrangement may include a working surface, cabinet, basin, and/or tap.

The camping paraphernalia supported by the support arrangement may be in the form of kitchen related facilities such as a stovetop, a microwave, a toaster, a kettle, cooking utensils, cutlery and crockery, food storage containers, a refrigerator, a heater, a gas cooker, and the like.

It is to appreciated that when the support arrangement is in the stowed condition, the support arrangement and sanitary ware may occupy a majority of the space in the compartment, thereby preventing user access to the sanitary ware. When the support arrangement is in the extended condition, the space previously occupied by the support arrangement may be sufficient to permit access to the compartment for use as a bathroom.

A plate may be attached to an end region of the support arrangement for blocking a view into the compartment during the extended condition. The plate may act as a barrier between the camping paraphernalia supported by support arrangement and the sanitary ware during the stowed condition.

The displacement mechanism may be in the form any one or more of the group including a rail arrangement, a telescoping slide, ball bearing slides, cabinet runners, and the like.

A handle may be provided for facilitating displacement of the support arrangement between the stowed and extended condition.

The compartment, support arrangement, and/or plate may be manufactured from any suitable material, preferably being suitable for campers, further preferably being a strong lightweight material. The material may be in the form of any one or more of the group including aluminium, fibreglass, wood, plywood, particle board, compressed board or the like.

The camper may include a second compartment. The second compartment may be defined by a framework of the camper. The second compartment may have a length, width and height in the ranges of 2 000 mm to 3 000 mm, 1 500 mm to 2 300 mm, and 1 800 mm to 2 200 mm, respectively, preferably having a length, width and height in the regions of 2 570 mm, 1 900 mm, and 2 000 mm. The second compartment may be located on an operatively rear end-region of the camper.

A second support arrangement may be mounted displaceably in the second compartment. The second support arrangement may be collapsible for facilitating storage thereof within the second compartment. The second support arrangement may be displaceable between an inoperative stowage condition wherein the second support arrangement is stowed within the second compartment, and an operative extended condition, wherein the second support arrangement is displaced out of the second compartment in order to permit use of the second support arrangement.

The second support arrangement may include a first portion. The first portion may define any one or more of the group including a bed base or bedstead, a bed foundation, a bed frame, a pallet bed, a divan base, a fold-up bedframe, a rollaway bedframe, an air mattress frame, an inflatable camping mat, a sleeping bag, a sleeping mat, and the like. The first portion may be sized to support a king-sized bedstead or two single-sized bedsteads.

The second support arrangement may include a second portion for supporting a second expansion arrangement for expanding the size of the second compartment in the extended condition. Preferably, the second expansion arrangement may increase the height of the second compartment, thereby improving the ergonomics of the second compartment.

The first and second portions may have generally planar, rectangular shapes. The portions may have a length, width and thickness in the ranges of 3 000 mm to 5 000 mm, 1 800 mm to 3 000 mm, and 500 mm to 800 mm, respectively, preferably having a length, width and thickness the regions of 2 650 mm, 2 000 mm, and 1 650 mm, respectively.

It is to be appreciated that in the operative extended condition, the second support arrangement may be displaced out of the second compartment in order to permit use of the first portion as a bedstead and the second portion as a ceiling or roof, thereby allowing the second compartment to be used as a bedroom.

The second expansion arrangement may include a panel which may define a ceiling or roof, typically being positioned substantially above the bedstead in the extended condition. The panel may be displaceable between a first stowage condition, wherein the panel is capable of being displaced into or out of the second compartment, and a second displaced condition, wherein the panel is displaced away from the bedstead, thereby permitting use thereof. The panel may be pivotally mounted on the second support, preferably via a hinge arrangement. The panel may have a generally rectangular shape. The panel may have a length, width, and thickness in the ranges of 1 500 mm to 2 500 mm, 1 000 mm to 2 000 mm, and 15 mm to 50 mm, respectively. Preferably, the panel may have a length, width, and thickness in the regions of 1 995 mm, 1 630 mm and 36 mm, respectively.

A second cover may be provided for covering an opening defined by the panel in the extended condition. The second cover may be utilised as a screen for creating privacy for the user or a barrier for reducing a likelihood of the ingress of water, leaves, dust, insects, debris, and the like. The second cover may be manufactured from any suitable material, preferably being a weather-resistant, a weather-proof, and/or a water-proof material. Preferably, the second cover may be manufactured from canvas.

A second displacement mechanism may be provided for displacing the second support arrangement between the stowage and extended conditions.

The second displacement mechanism may be in the form any one or more of the group including a rail arrangement, a telescoping slide, ball bearing slides, cabinet runners, and the like. In particular, the second displacement mechanism may be in the form of a rack-and-rail assembly, which is capable of permitting the second support arrangement to extend from the second compartment a distance in the range of 0.5 m to 3.5 m, typically in the region of 2 m.

The second support arrangement may be manufactured from any suitable material, preferably being suitable for campers, further preferably being a strong lightweight material. The material may be in the form of any one or more of the group including aluminium, fibreglass, wood, plywood, particle board, compressed board or the like.

A handle may be provided for facilitating displacement of the second support arrangement between the stowed and extended condition.

According to a second aspect of the invention, there is provided a camper including:
a compartment;
a support arrangement including first and second supports which are mounted displaceably within the compartment:
a displacement arrangement for allowing displacement of the support arrangement between an inoperative stowed condition, wherein the support arrangement is stowed within the compartment, and an operative extended condition, wherein the support arrangement is displaced out of the compartment in order to permit use of the first support as a bedstead and the second support as a roof.

### BRIEF DESCRIPTION OF THE DRAWINGS

A camper in accordance with the invention will now be described by way of the following, non-limiting examples with reference to the accompanying drawings.

In the drawings:

FIG. 1 is a two-dimensional schematic showing a side view of an exterior of a camper in accordance with the present invention, in an extended condition;

FIG. 2 is a two-dimensional schematic showing a side view of an exterior of the camper in a stowed condition;

FIG. 3 is a two-dimensional schematic showing a top view of an interior of a camper along line “A-A” on FIG. 1;

FIG. 4 is a two-dimensional schematic showing a top view of an interior of a camper along line “B-B” on FIG. 2;

FIG. 5 is a three-dimensional schematic showing the camper in a stowed condition;

FIG. 6 is an enlarged three-dimensional view showing a portion of the exterior of the camper in the stowed condition, the location of the enlarged view being marked “C” on FIG. 5;

FIG. 7 is an enlarged three-dimensional view showing a portion of the exterior of the camper in the extended condition, the location of the enlarged view being marked “C” on FIG. 5;

FIG. 8 is a is a two-dimensional schematic showing a side view of the exterior of the camper, in an extended condition;

FIG. 9 is a two-dimensional schematic showing a top view of the interior of the camper along line “D-D” on FIG. 8; and

FIG. 10 is a three-dimensional schematic showing the camper in an extended condition.

### DETAILED DESCRIPTION OF THE INVENTION

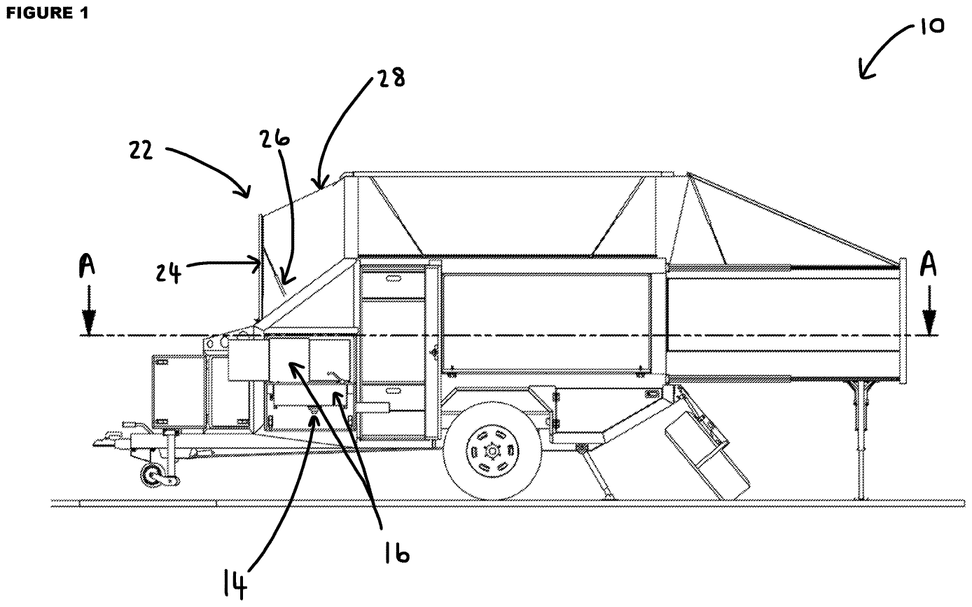

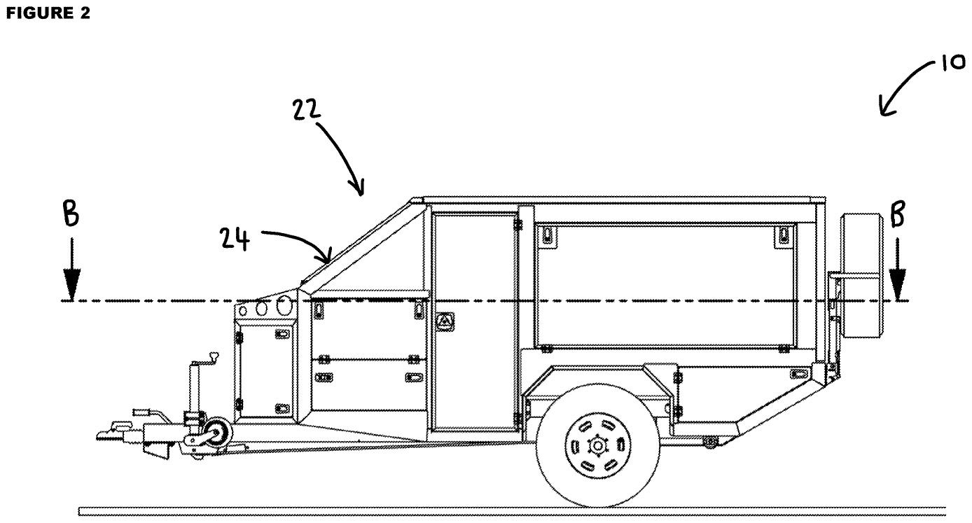

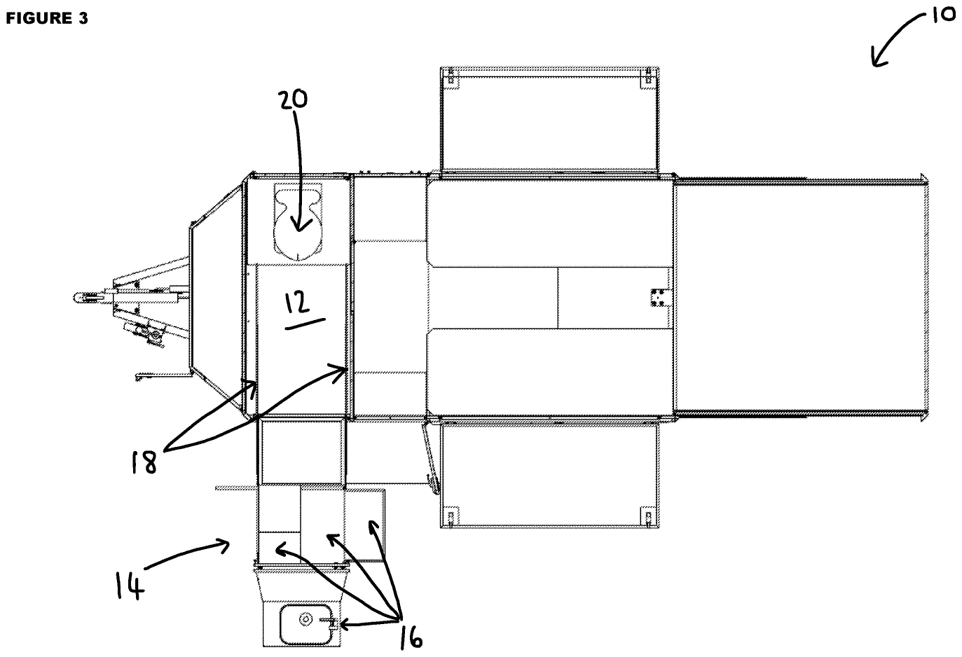

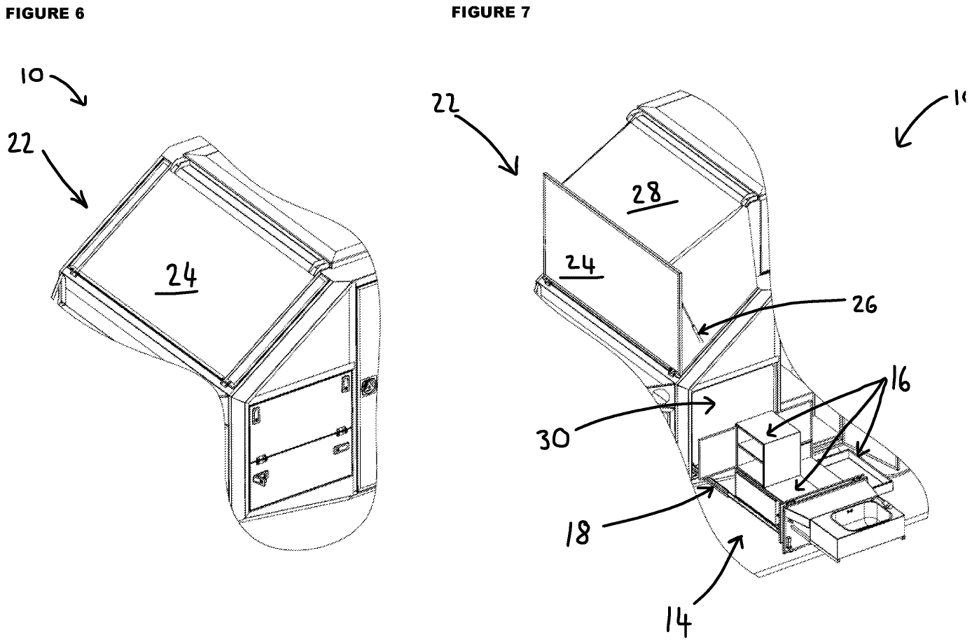

Referring now to FIGS. 1-7, reference numeral 10 refers generally to a camper 10 including a compartment 12, sanitary ware mounted within the compartment 12, a support arrangement 14 mounted displaceably within the compartment 12 for supporting camping paraphernalia 16, and a displacement mechanism 18 for allowing displacement of the support arrangement 14 between a stowed condition, wherein the support arrangement 14 is stowed within the compartment 12, and an extended condition, wherein the support arrangement 14 is displaced out of the compartment 12 in order to permit access to the compartment 12, use of the sanitary ware, and use of the camping paraphernalia 16.

For the purpose of this specification, the term “camper” should be understood to mean any form of vehicle suitable for camping, such as a caravan, trailer, motorhome, RV (recreational vehicle), and the like.

The compartment 12 is defined by a framework of the camper 10. The compartment 12 has a length, width, and height in the ranges of 1 000 mm to 2 000 mm, 500 mm to 1 000 mm, and 1 200 mm to 2 500 mm, respectively, typically in the regions of 1 940 mm, 840 mm, and 2 200 mm, respectively. The compartment 12 is located on an operatively front end-region of the camper 10, as clearly shown in FIG. 1.

It is to be appreciated that a framework of the camper 10 defines a living space, a floor, a roof, side walls, and a chassis assembly including wheels mounted thereon for supporting the framework.

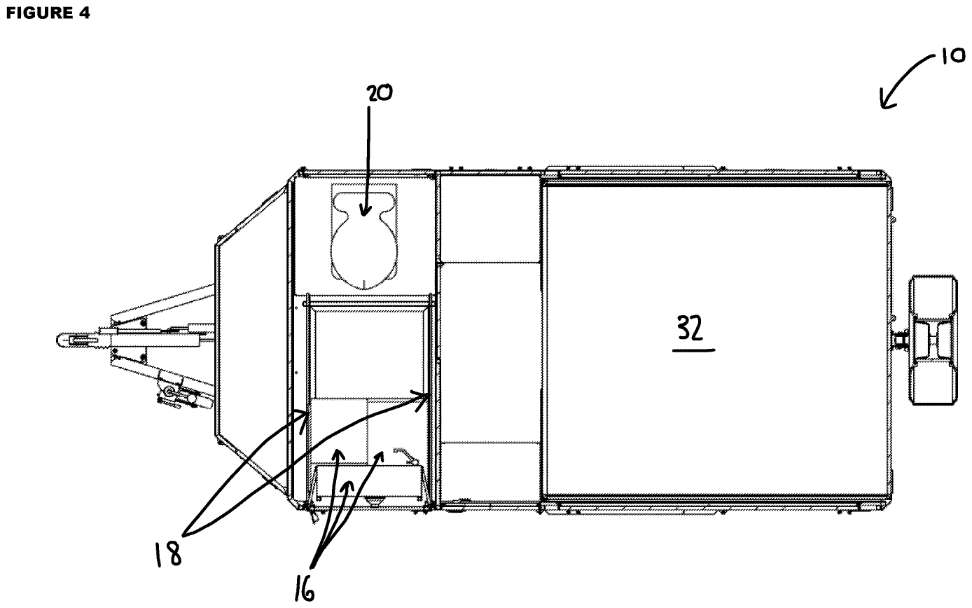

The sanitary ware includes any plumbing fixtures typically found in a bathroom. Typically, the sanitary ware includes any one or more plumbing fixtures of the group including toilets, toilet bowls, basins, sinks, showers, bathtubs, and taps. The sanitary ware is collapsible or foldable into secondary compartments within the first compartment 12. It is to be appreciated that the sanitary ware is inaccessible by the user when the first support arrangement 14 is in a stowed condition within the first compartment 12, as clearly shown in FIG. 4. The sanitary ware is manufactured from any suitable material including ceramic, plastics, or metal. As shown in the figures, the sanitary ware includes a toilet 20. The toilet 20 is located towards a side region of the first compartment.

An expansion arrangement 22 is provided for expanding the size of the compartment 12, typically the height of the compartment 12 for facilitating standing therein by the user.

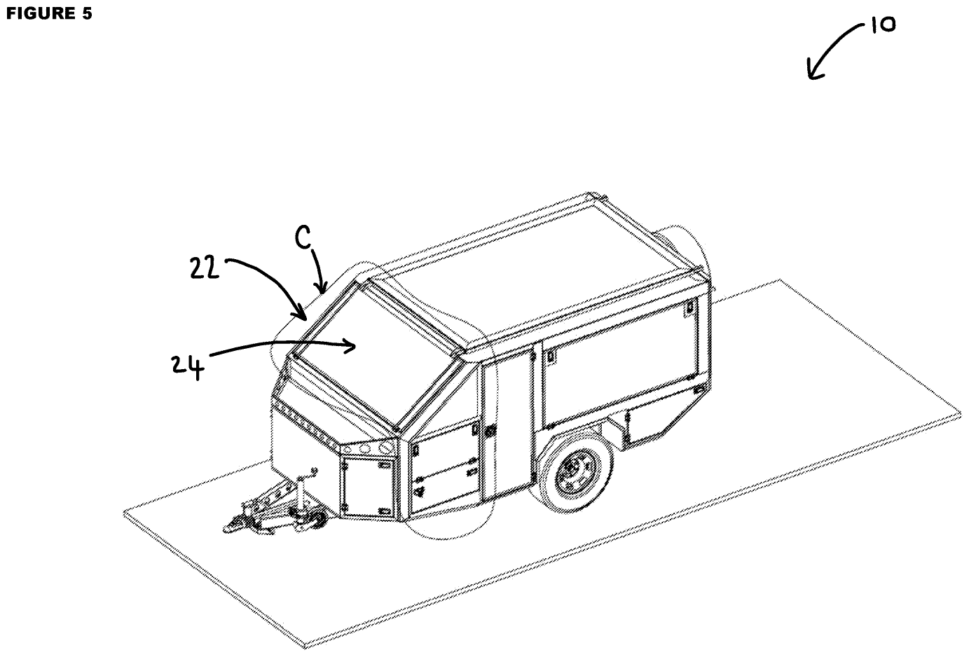

The expansion arrangement 22 includes a panel 24 which defines a roof panel of the compartment 12 in the stowed condition. The panel 24 is arranged at an incline relative to side walls of the camper 10. It is to be appreciated that mounting the panel 24 at an incline can improve compactness and aerodynamics of the camper 10 when traveling. The panel 24 is mounted on the framework of the camper 10 so as to be displaceable between a first condition, wherein the compartment 12 is in the stowed condition, and a second displaced condition, wherein the panel 24 is displaced away from the compartment 12 thereby increasing the volume thereof. The panel 24 is mounted on the framework via a hinge arrangement. Hydraulic actuators 26 extend between and interconnect the panel 24 and the framework of the camper 10 for facilitating the displacement of the panel 24 into the expanded condition. The panel 24 has a generally rectangular shape. The panel 24 has a length, width, and thickness in the ranges of 1 600 mm to 2 000 mm, 800 mm to 1 000 mm, and 15 mm to 30 mm, respectively. Typically, the panel 24 has a length, width, and thickness in the regions of 1 800 mm, 900 mm and 20 mm, respectively. It is to be appreciated that the panel 24 acts as a side wall of the compartment 12 in the displaced condition, as clearly shown in FIG. 5.

A cover 28 is provided for covering an opening in the compartment 12 defined by the panel 24 in the displaced condition. The cover 28 is utilised as any one or more of the group including a screen for creating privacy for the user using the sanitary ware, a roof, and a barrier for reducing a likelihood of the ingress of water, leaves, dust, insects, debris, and the like. The cover 28 is generally rectangular in shape. The cover 28 has a length, width, and thickness in the ranges of 1 300 mm to 1 800 mm, 500 mm to 900 mm, and 0.5 mm to 2.5 mm, respectively. Typically, the cover 28 has a length, width, and thickness in the regions of 1 450 mm, 770 mm and 1.2 mm, respectively. The cover 28 is manufactured from any suitable material, typically being a weather-resistant, a weather-proof, or a water-proof material. Typically, the cover 28 is manufactured from canvas.

The support arrangement 14 is collapsible for facilitating stowage thereof in the compartment 12. The support arrangement 14 has a length, width and height in the ranges of 1 000 mm to 2 000 mm, 500 mm to 800 mm, and 500 mm to 800 mm, respectively, typically having a length, width and height in the regions of 1 200 mm, 700 mm, and 660 mm, respectively, in the stowed condition. The support arrangement 14 has a length, width and height in the ranges of 800 mm to 2 000 mm, 500 mm to 2 000 mm, and 500 mm to 1 000 mm, respectively, typically having a length, width and height the regions of 1 850 mm, 771 mm, and 786 mm, respectively, in the extended condition. The support arrangement 14 defines any one or more of the group including a working surface, a worktop, a table, a cabinet, a cupboard, and a sink. Typically, the support arrangement 14 includes a working surface, cabinet, basin, and/or tap.

The camping paraphernalia 16 supported by the support arrangement 14 is in the form of kitchen related facilities such as a stovetop, a microwave, a toaster, a kettle, cooking utensils, cutlery and crockery, food storage containers, a refrigerator, a heater, a gas cooker, and the like.

It is to appreciated that when the support arrangement 14 is in the stowed condition, the support arrangement 14 and sanitary ware, including the toilet 20, occupies a majority of the space in the compartment 12, thereby preventing user access to the sanitary ware, including the toilet 20, as clearly shown in FIG. 4. When the support arrangement 14 is in the extended condition, the space previously occupied by the support arrangement 14 is sufficient to permit access to the compartment 12 for use as a bathroom.

A plate 30 is attached to an end region of the support arrangement 14 for blocking a view into the compartment 12 during the extended condition, as clearly shown in FIG. 7. The plate 30 acts as a barrier between the camping paraphernalia 16 supported by support arrangement 14 and the sanitary ware during the stowed condition.

The displacement mechanism 18 is in the form any one or more of the group including a rail arrangement, a telescoping slide, ball bearing slides, cabinet runners, and the like.

A handle (not shown) is provided for facilitating displacement of the support arrangement 14 between the stowed and extended condition.

The compartment 12, support arrangement 14, and plate 30 are manufactured from any suitable material, typically being suitable for campers, further typically being a strong lightweight material. The material is in the form of any one or more of the group including aluminium, fibreglass, wood, plywood, particle board, compressed board or the like.

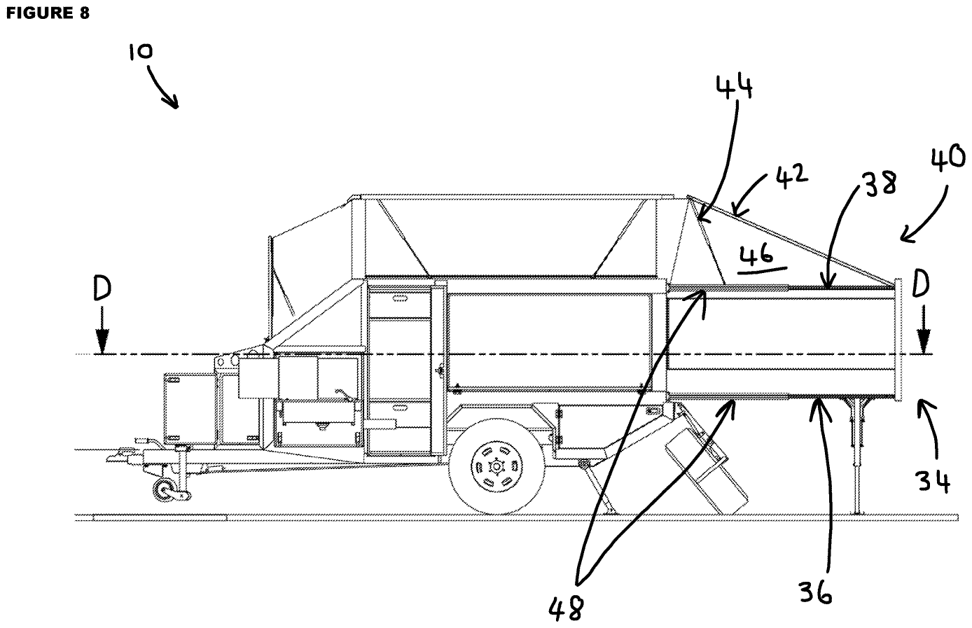

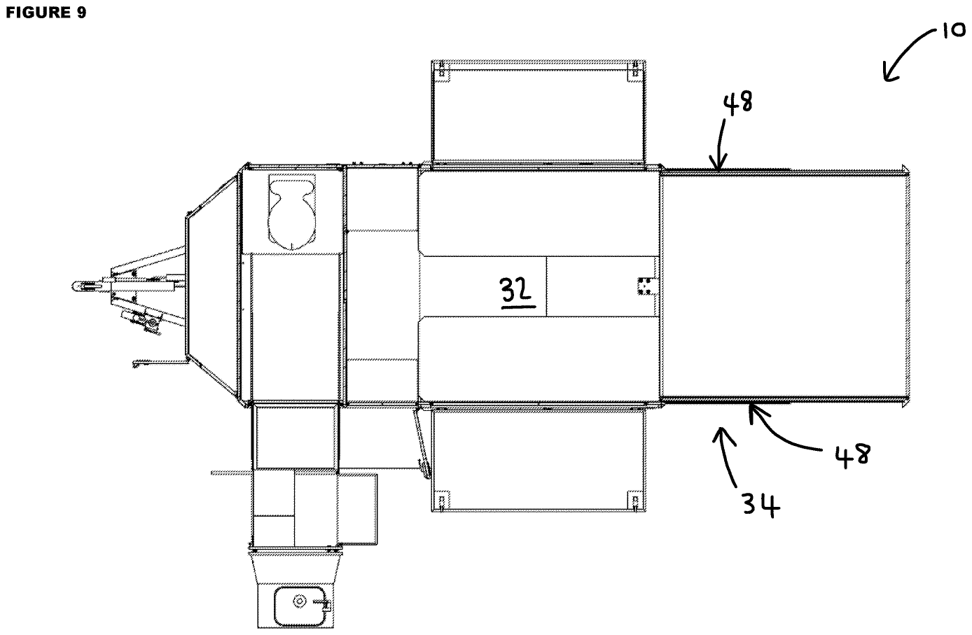

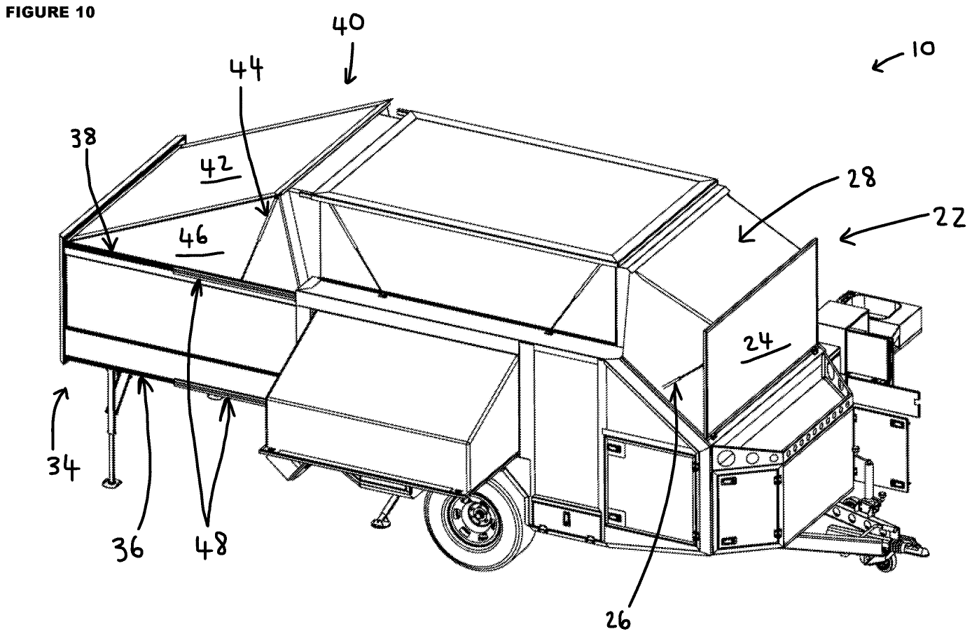

Referring now to FIGS. 8 to 10, the camper 10 includes a second compartment 32. The second compartment 32 is defined by a framework of the camper 10. The second compartment 32 has a length, width and height in the ranges of 2 000 mm to 3 000 mm, 1 500 mm to 2 300 mm, and 1 800 mm to 2 200 mm, respectively, typically having a length, width and height in the regions of 2 570 mm, 1 900 mm, and 2 000 mm. The second compartment 32 is located on an operatively rear end-region of the camper 10, as clearly shown in FIG. 8 and FIG. 9.

A second support arrangement 34 is mounted displaceably in the second compartment 32. The second support arrangement 34 is collapsible for facilitating storage thereof within the second compartment 32. The second support arrangement 34 is displaceable between an inoperative stowage condition wherein the second support arrangement 34 is stowed within the second compartment 32, and an operative extended condition, wherein the second support arrangement 34 is displaced out of the second compartment 32 in order to permit use of the second support arrangement 34.

The second support arrangement 34 includes a first portion 36. The first portion 36 defines any one or more of the group including a bed base or bedstead, a bed foundation, a bed frame, a pallet bed, a divan base, a fold-up bedframe, a rollaway bedframe, an air mattress frame, an inflatable camping mat, a sleeping bag, a sleeping mat, and the like. The first portion 36 is sized to support a king-sized bedstead or two single-sized bedsteads. For the purposes of this specification, the term “king-size bedstead” should be understood to mean a large bed base or framework of a bed having a length and width in the range of 1 500 mm to 2 000 mm, and 1 700 mm to 2 100 mm, respectively, and the term “single-size bed” should be understood to mean a bed having a length and width in the range of 700 mm to 1 200 mm, and 1 700 mm to 2 000 mm, respectively.

The second support arrangement 34 includes a second portion 38 for supporting a second expansion arrangement 40 for expanding the size of the second compartment 32 in the extended condition. Typically, the second expansion arrangement 40 increases the height of the second compartment 32, thereby improving the ergonomics of the second compartment 32, as clearly shown in FIG. 10.

The first and second portions 36, 38 have generally planar, rectangular shapes. The portions 36, 38 have a length, width and thickness in the ranges of 3 000 mm to 5 000 mm, 1 800 mm to 3 000 mm, and 500 mm to 800 mm, respectively, typically having a length, width and thickness the regions of 2 650 mm, 2 000 mm, and 1 650 mm, respectively.

It is to be appreciated that in the operative extended condition, the second support arrangement 34 is displaced out of the second compartment 32 in order to permit use of the first portion 36 as a bedstead and the second portion 38 as a ceiling or roof, thereby allowing the second compartment 32 to be used as a bedroom.

The second expansion arrangement 40 includes a panel 42 which defines a ceiling or roof, typically being positioned substantially above the bedstead in the extended condition. The panel 42 is displaceable between a first stowage condition, wherein the panel 42 is capable of being displaced into or out of the second compartment, and a second displaced condition, wherein the panel 42 is displaced away from the bedstead, thereby permitting use thereof. The panel 42 is pivotally mounted on the second support, typically via a hinge arrangement. Hydraulic actuators 44 extend between and interconnect the panel 42 and the framework of the camper 10 for facilitating the displacement of the panel 42 into the expanded condition. The panel 42 has a generally rectangular shape. The panel 42 has a length, width, and thickness in the ranges of 1 500 mm to 2 500 mm, 1 000 mm to 2 000 mm, and 15 mm to 50 mm, respectively. Typically, the panel 42 has a length, width, and thickness in the regions of 1 995 mm, 1 630 mm and 36 mm, respectively.

A second cover 46 is provided for covering an opening defined by the panel in the extended condition. The second cover 46 is utilised as a screen for creating privacy for the user or a barrier for reducing a likelihood of the ingress of water, leaves, dust, insects, debris, and the like. The second cover 46 is manufactured from any suitable material, typically being a weather-resistant, a weather-proof, and/or a water-proof material. Typically, the second cover 46 is manufactured from canvas.

A second displacement mechanism 48 is provided for displacing the second support arrangement 34 between the stowage and extended conditions. The second displacement mechanism 48 is in the form any one or more of the group including a rail arrangement, a telescoping slide, ball bearing slides, cabinet runners, and the like. In particular, the second displacement mechanism 48 is in the form of a rack-and-rail assembly, which is capable of permitting the first and second portions 36 and 38 to extend from the second compartment 32 a distance in the range of 0.5 m to 3.5 m, typically in the region of 2 m.

The second support arrangement 34 is manufactured from any suitable material, typically being suitable for campers, further typically being a strong lightweight material. The material is in the form of any one or more of the group including aluminium, fibreglass, wood, plywood, particle board, compressed board or the like.

A handle (not shown) is provided for facilitating displacement of the second support arrangement 34 between the stowed and extended condition.

It is, of course, to be appreciated that the camper in accordance with the invention is not limited to the precise constructional and functional details as hereinbefore described with reference to the accompanying drawings and which can be varied as desired.

The inventor believes that the camper in accordance with the present invention is advantageous in that it makes better use of the space available within the framework of the camper by making use of a compartment as a stowage area when the camper is not in use and making use of the compartment as a bathroom area when the camper is in use. The length and height of the compartment which is used as a bathroom in the extended condition is substantially increased, thereby allowing the user to enjoy a comfortable in-door shower, washing space and/or dress room in which they can stand up. This is advantageous as it is generally rare to have a bathroom within a camper that proves a substantial amount of space for actions described above as well as in-door hanging and drying of towels and clothing.

The length and height of the compartment which is used as a bedroom in the extended condition is substantially increased, thereby allowing the user to enjoy a comfortable bedroom, fitted with bedroom paraphernalia. This is advantageous as it is generally rare to have a king-size bed in a camper and allows for more comfortable use.

1. A camper including:
a compartment;
sanitary ware mounted within the compartment;
a support arrangement mounted displaceably within the compartment for supporting camping paraphernalia; and
a displacement mechanism for allowing displacement of the support arrangement between a stowed condition, wherein the support arrangement is stowed within the compartment, and an extended condition, wherein the support arrangement is displaced out of the compartment in order to permit access to the compartment, use of the sanitary ware, and use of the camping paraphernalia.

2. The camper as claimed in claim 1 wherein the compartment is defined by a framework of the camper.

3. (canceled)

4. The camper as claimed in claim 1 wherein the sanitary ware is collapsible or foldable into secondary compartments within the first compartment.

5. The camper as claimed in any one or more of the preceding claim 1 wherein the sanitary ware includes a toilet.

6. The camper as claimed in claim 1 wherein an expansion arrangement is provided for expanding the size of the compartment.

7. The camper as claimed in claim 6 wherein the expansion arrangement includes a panel which defines a roof panel of the compartment in the stowed condition.

8. (canceled)

9. The camper as claimed in any one or more of the preceding claim 7 wherein hydraulic actuators extends between and interconnect the panel and the framework of the camper for facilitating the displacement of the panel into the displaced condition.

10. The camper as claimed in claim 7 wherein a cover is provided for covering an opening in the compartment defined by the panel in the displaced condition.

11. The camper as claimed in claims claim 1 wherein the support arrangement is collapsible for facilitating stowage thereof in the compartment.

12. The camper as claimed in claim 1 wherein a plate is attached to an end region of the support arrangement for blocking a view into the compartment during the extended condition.

13. (canceled)

14. (canceled)

15. The camper as claimed in claim 1 wherein the camper includes a second compartment, which is defined by a framework of the camper.

16. (canceled)

17. The camper as claimed in claim 15 wherein a second support arrangement is mounted displaceably in the second compartment.

18. (canceled)

19. The camper as claimed in claim 17 8 wherein the second support arrangement is displaceable between an inoperative stowage condition wherein the second support arrangement is stowed within the second compartment, and an operative extended condition, wherein the second support arrangement is displaced out of the second compartment in order to permit use of the second support arrangement.

20. The camper as claimed in claim 17 wherein the second support arrangement includes a first portion which defines any one or more of the group including a bed base or bedstead, a bed foundation, a bed frame, a pallet bed, a divan base, a fold-up bedframe, a rollaway bedframe, an air mattress frame, an inflatable camping mat, a sleeping bag, and a sleeping mat.

21. (canceled)

22. (canceled)

23. The camper as claimed in claim 17 wherein the second support arrangement includes a second portion for supporting a second expansion arrangement for expanding the size of the second compartment in the extended condition.

24. The camper as claimed in claim 23 wherein the second expansion arrangement includes a panel which defines a ceiling or roof.

25. The camper as claimed in claim 24 wherein the panel is displaceable between a first stowage condition, wherein the panel is capable of being displaced into or out of the second compartment, and a second displaced condition, wherein the panel is displaced away from the bedstead, thereby permitting use thereof.

26. The camper as claimed in claim 24 wherein the panel is pivotally mounted on the second support.

27. The camper as claimed in claim 24 wherein a second cover is provided for covering an opening defined by the panel in the extended condition.

28. The camper as claimed in claim 19 wherein a second displacement mechanism is provided for displacing the second support arrangement between the stowage and extended conditions.

29. (canceled)
